(19) United States
(12) Patent Application Publication
(10) Pub. No.: US 2024/0419998 A1
(43) Pub. Date: Dec. 19, 2024

(54) STOCHASTIC LEARNING OF COMPUTING INPUTS

(71) Applicant: J4 Capital LLC, Highland Park, IL (US)

(72) Inventor: Jeff Glickman, Woodinville, WA (US)

(21) Appl. No.: 18/736,122

(22) Filed: Jun. 6, 2024

Related U.S. Application Data
(60) Provisional application No. 63/521,528, filed on Jun. 16, 2023.

(51) Int. Cl. G06N 7/08; G06N 20/00

(52) U.S. Cl. CPC G06N 7/08; G06N 20/00

(57) ABSTRACT

A method includes accessing, using a computing system, data including a plurality of variables, each variable having one or more elements. The method includes determining stochastic partial differences between elements of respective variables of the plurality of variables and combining respective stochastic partial differences into groups including one or more stochastic partial difference equations (SPDEs). The method includes evaluating, using a fitness measure criterion, the one or more SPDEs in relation to an objective function. The method includes determining, by the computing system, based on the evaluating, a prediction related to at least one data input to an application executable by one of the computing system or a second computing system communicatively coupled to the computing system. The at least one data input relies, at least in part, on one or more of the plurality of variables.

### CLAIM OF PRIORTY

The present application claims the benefit under 35 U.S.C. § 119 (e) of U.S. Provisional Patent Application No. 63/521,528, filed Jun. 16, 2023, which is incorporated by this reference herein.

### TECHNICAL FIELD

Embodiments of the disclosure relate generally to machine learning (ML) and artificial intelligence (AI), and more specifically, relate to stochastic learning of computing inputs.

### BACKGROUND

Artificial intelligence (AI), including machine learning (ML), neural networks (NNs), and deep learning (e.g., using DNNs) are limited in their ability to address large-scale problems by their computational complexity and power consumption. In February 2023, the Chief Executive Office of Advanced Micro Devices, Dr. Lisa Su, estimated that a zettaflop supercomputer built with 2023 technology would require 21 nuclear power plants (ISSCC Trade Show, February 2023, San Francisco). The current power grid cannot supply the needed electricity, nor is there sufficient fresh water available to provide water cooling for this level of heat dissipation. The exponential growth of the use of artificial intelligence is not sustainable.

### BRIEF DESCRIPTION OF THE DRAWINGS

A more particular description of the disclosure briefly described above will be rendered by reference to the appended drawings. Understanding that these drawings only provide information concerning typical embodiments and are not therefore to be considered limiting of its scope, the disclosure will be described and explained with additional specificity and detail through the use of the accompanying drawings.

FIG. 1 is a block diagram of an example computing system configured to perform stochastic learning according to various embodiments.

FIG. 2 is an operational flow chart illustrating a method of performing stochastic learning that enables dynamic modification of data inputs to an application according to at least some embodiments.

FIG. 3 is a flow chart of a method for stochastic learning of a computing input according to at least one embodiment.

FIG. 4 is a computing system that may be used for or in conjunction with any of the disclosed methods according to the embodiments disclosed herein.

### DETAILED DESCRIPTION

By way of introduction, the present disclosure relates to stochastic learning of one or more computing inputs, providing practical applications to stochastic learning by modifying data inputs to computing that are predictive of objective functions. Thus, such stochastic learning can be applied in many kinds of fields as a more efficient replacement to traditional machine learning or artificial intelligence generally employed today. For example, different from deterministic methods typical of artificial intelligences, the disclosed methods employ stochastic representations and stochastic computations to reduce the computing requirements and the concomitant processing needs typical of machine learning.

Discrete or deterministic values, e.g., cardinal counts, generally do not practically exist in the real world. Most real-world mathematical analyses require some level of estimation, which lends itself to statistical analysis. One field that can be leveraged in that regard is stochastic processes. There exist entire branches of mathematics built on statistical abstractions. Stochastic computing can be understood as a collection of techniques that represent continuous values by streams of random bits. Complex computations can then be computed by simple bit-wise operations on the streams. Stochastic computing is distinct from the study of randomized algorithms.

For purposes of explanation, suppose that p, q∈[0,1] is given, and one desires to compute p×q. Stochastic computing performs this operation using probability instead of arithmetic. Specifically, suppose that there are two random, independent bit streams called stochastic numbers (e.g., Bernoulli processes), where the probability of a one (“1”) in the first stream is p and the probability of a one (“1”) in the second stream is q. One can take the logical AND of the two streams. The probability of a one in the output stream (from this logical AND) is the product pq. By observing enough output bits and measuring the frequency of ones, it is possible to estimate this product to arbitrary accuracy.

The operation above converts a fairly complicated computation (multiplication of p and q) into a series of very simple operations (evaluation of aᵢΛbᵢ) on random bits. More generally speaking, stochastic computing represents numbers as streams of random bits and reconstructs numbers by calculating frequencies. The computations are performed on the streams and translate complicated operations on p and q into simple operations on their stream representations. (Because of the method of reconstruction, devices that perform these operations are sometimes called stochastic averaging processors.) In modern terms, stochastic computing can be viewed as an interpretation of calculations in probabilistic terms, which are then evaluated with a Gibbs sampler. Stochastic computing may also be viewed as a hybrid analog and digital computer.

The origin of stochastics included analyzing whether the probability that something occurs is greater than a particular value. Simple bit streams came to represent probabilities. Burst representation and bundle representation have also been used. The above discussion about stochastics generally employs a sliding window along the bit stream that counts up the number of 1s or 0s in that window. This could be implemented with an accumulator, for example, that weighs each bit the same. The count of these 1s or 0s could be used to do additional processing, where the count is a weighted binary number that represents the stochastic probability of the underlying bit stream. The world around us arises from stochastic processes described by the Schrödinger equation or similar constructs such as the Madelung equations, the equations of quantum hydrodynamics, or the like.

Aspects of the present disclosure address the above and other deficiencies of traditional machine learning and aritifical intelligence by integrating the field of differential equations that stemmed from the Schrödinger equation with stochastic processing as will be explained. The Schrödinger equation is a linear partial differential equation that governs the wave function of a quantum-mechanical system. Its discovery was a significant landmark in the development of quantum mechanics.

Conceptually, the Schrödinger equation is the quantum counterpart of Newton's second law in classical mechanics. Given a set of known initial conditions, Newton's second law makes a mathematical prediction as to what path a given physical system will take over time. The Schrodinger equation gives the evolution over time of a wave function, the quantum-mechanical characterization of an isolated physical system. The equation can be derived from the fact that the time-evolution operator is unitary, and must, therefore, be generated by the exponential of a self-adjoint operator, which is the quantum Hamiltonian.

The Schrödinger equation is not the only way to study quantum mechanical systems and make predictions. The other formulations of quantum mechanics include matrix mechanics, introduced by Werner Heisenberg, and the path integral formulation, developed chiefly by Richard Feynman. Paul Dirac incorporated matrix mechanics and the Schrödinger equation into a single formulation. When these approaches are compared, the use of the Schrödinger equation is sometimes called “wave mechanics.”

In some embodiments, the natural world can be viewed as a composition of stochastic processes. This notion is supported by the laws of thermodynamics and quantum theory. Nonetheless, humans perceive the world in a deterministic manner, likely due to the limited capabilities of the human brain, making determinism a useful abstraction for simplifying the vast complexity of a stochastic reality to aid human comprehension. For example, a number which is a constant metric on a physical entity is an abstraction because a metric on a stochastic system cannot be continuously the same. As a constant, the number instead defines an average metric on the stochastic system if the number remains unchanged over a defined period. Taking this one step further, a deterministic abstraction can be interpreted as a special case of stochastics or stochastic processing.

Deterministic systems have limitations, however. For example, a deterministic system of partial differential equations can be more difficult to solve than a stochastic system of partial differential equations. A partial differential equation can be understood as the change of one variable with respect to another variable related to the same physical system or construct. For purposes of explanation, imagine A exists with respect to B and B exists with respect to C, then there exist (n−1)² differentials that may be expressed using variables A, B, and C. In various embodiments, these differentials have very powerful stochastic information. An AND operator is a multiplication in probabilistic space, for example, and similar operators may be employed to perform other types of stochastic operations, e.g., arithmetic operations. The values of A, B, and C can be thought of as probabilistic (P) values that can be acted upon as they exist, which is in weighted binary form.

In various embodiments, which will be explained in more detail, these P values need not be translated into another form to be processed, e.g., run through these differentials and recombined. In these embodiments, by acting directly on the detected weighted binary values in existing data, the disclosing computing system(s) generate remarkable. high-dimensional pattern spaces that are predictive of stochastic learning described herein.

Leaning on the observation that deterministic abstractions can be viewed as special cases of stochastics, deterministic systems of partial differential equations can be reframed within the superset of stochastic systems and be more easily processed. This is asymmetric though, as stochastic systems cannot be readily reframed within the subset of deterministic systems. Once in a stochastic form, however, solutions are more forthcoming.

In some embodiments, a disclosed method includes accessing, using a computing system, data including a plurality of variables, each variable having one or more elements. For example, in some embodiments, the elements are multidimensional values of a multidimensional variable of the plurality of variables. More specifically, at least one variable of the plurality of variables has multiple dimensions and each value of the multidimensional variable is an element of the one or more elements. In embodiments, the method includes determining stochastic partial differences between elements of respective variables of the plurality of variables and combining respective stochastic partial differences into groups including one or more stochastic partial difference equations (SPDEs). The method includes evaluating, using a fitness measure criterion (or multiple fitness measure criteria), the one or more SPDEs in relation to an objective function (or multiple objective functions). The method includes determining, by the computing system, based on the evaluating, a prediction related to (or of) at least one data input to an application executable by one of the computing system or a second computing system communicatively coupled to the computing system, as will be described in more detail. In some embodiments, the at least one data input relies, at least in part, on one or more of the plurality of variables

Therefore, advantages of the systems and methods implemented in accordance with some embodiments of the present disclosure include, but are not limited to, avoiding the need to preprocess data before stochastically analyzing the data, avoiding the need for feature engineering subsets of the data, and thus eliminating the need to convert the data into another representation to process the data stochastically. Additional advantages of the disclosed stochastic learning include the ability to perform the stochastic learning without supervision, e.g., without supervised learning. In embodiments, the disclosed direct stochastic computation is inherently parallelizable, enabling high-speed implementations, which are also, compared to traditional machine learning, more accurate, faster to develop a prediction, consumes less power, and thus less water for cooling, providing benefits of greener, lower-capital expense, and higher profits for commercial enterprises. Other advantages will be apparent to those skilled in the art of stochastic-based machine learning or artificial intelligence, which will be discussed hereinafter.

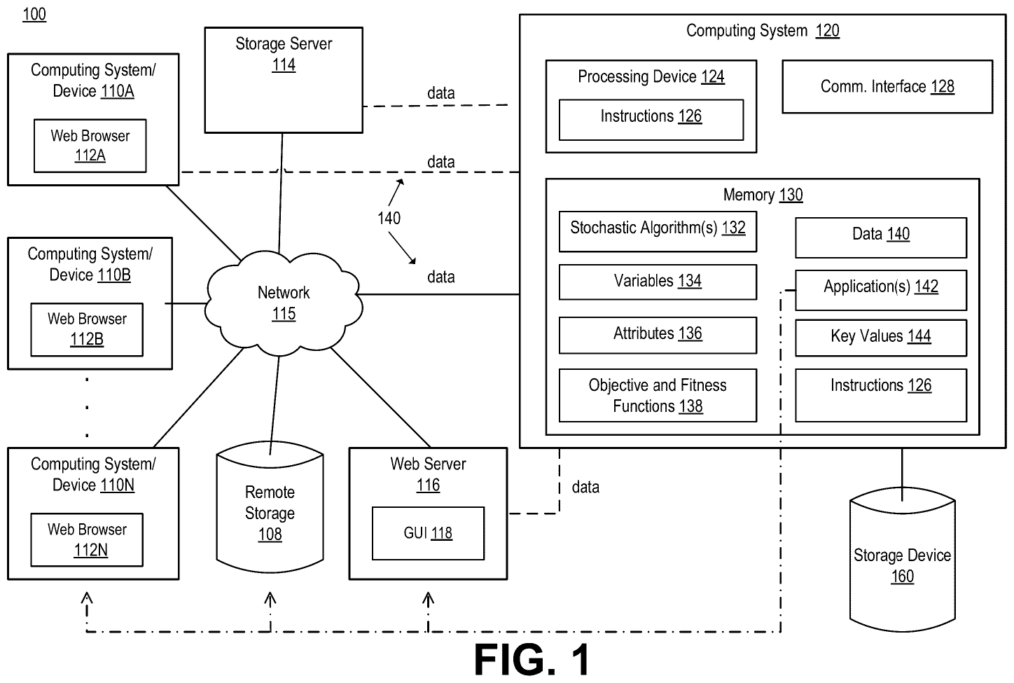

FIG. 1 is a block diagram of an example computing system 100 configured to perform stochastic learning according to various embodiments. In at least some embodiments, the system 100 includes a computing system 120 that is configured to perform the stochastic learning based on data 140 retrieved from a storage device 160 and/or received from other systems or devices, optionally over a network 115. In various embodiments, the data may be represented by a stream of bits that are retrieved and/or received over time.

In at least some embodiments, the system 100 further includes a remote storage 108, a storage server 114, one or more computing systems/devices 110A, 110B, . . . 110N, and/or at least one web server 116 communicatively coupled to the computing system 120 over the network 115. The computing systems/devices 110A, 110B, . . . 110N may each include a web browser 112A, 112B, . . . 112N, respectively, through which users may submit data to the computing system 120. In some embodiments, the web server 116 includes a graphical user interface (GUI), and/or other communication interface, which is accessible over the network 115 or directly by the computing system 120 and may be employed to retrieve the data 140 from many online sources, including those illustrated in FIG. 1.

In various embodiments, the computing system 120 includes a processing devcie 124 configured to execute instructions 126 and communicate with the other systems or devices via a communication interface 128. In these embodiments, the computing system 120 also includes a memory 130 to store the at least some of the instructions 126 in addition to stochastic algorithms 132, related various parameters, values, and the data 140. In some embodiments, the processing device 124 includes one or more processing devices, at least some of which can be distributed across the network 115 and may be located in multiple computing devices of a datacenter, for example. In some embodiments, the memory 130 is memory communicatively coupled with and readable by the one or more processing devices and has stored therein processor-readable instructions which, when executed by the one or more processing devices, cause the one or more processing devices to perform operations disclosed herein.

In embodiments, the data 140 is received from the other systems and devices illustrated in FIG. 1 and be temporarily stored in the memory 130 while being stochastically processed. The above-mentioned related parameters may include variables 134, attributes 136, objective and fitness functions 138, and key values 144, all of which may be employed in the disclosed stochastic leanring that will be discussed in more detail. In some embodiments, the processing device 124 treats these related parameters to the keys values 144, which may be indexed within the storage device 160 and thus accessed at a later time for reference and/or for further analysis related to predictions of input data.

In various embodiments, the memory 130 stores applications 142 or the instructions 126 for executing such applications that employs the data 140 to function, e.g., to provide useful information to users of such applications in a field of computing that has been subject to traditional ML/AI. In some embodiments, the applications 142 are executed by one of the computing systems/devices 110A . . . 110N, the storage server 114, and/or the web server 116. In some embodiments, these applications 142 receive data input(s) from the processing device 124 as a result of or in response to the processing device 124 executing stochastic algorithims 132 or other stochastic learning associated with the data 140 being processed.

Artificial intelligence (AI) typically uses a deterministic information representation in the form of weighted binary numbers or other deterministic representations. In at least some embodiments, the disclosed learning approach uses a stochastic information representation as compared to deterministic information representations that are typically used by other artificial intelligences. This stochastic information representation differs with respect to prior stochastic information representations. For example, prior or existing stochastic computational systems typically use streams of random bits to represent stochastic information. One alternate stochastic method known as “burst processing” employs fixed window lengths on streams of random bits. In these systems, bits have the same weight of one (“1”), in contrast to classical deterministic computers that typically use weighted binary values for information representation.

In various embodiments, the disclosed stochastic learning approach employs a new stochastic information representation, which is referred to herein as “direct stochastic processing.” In contrast to other stochastic computational systems, this direct stochastic processing approach uses weighted binary to represent the count of stochastic bits over a window. This has several unique advantages. For example, in various embodiments, these advantages include that data conversion is not required, e.g., data is accessed without pre-processing the data and without performing feature engineering on the data. Data, which was previously interpreted as deterministic, may instead be interpreted as stochastic, remains in a weighted binary representation, and remains in place and does not need conversion. There are neither computation costs nor memory transfer costs associated with this approach. For example, no special hardware may be required to perform the disclosed stochastic learning and current computing systems may be considered backwards compatible in implementation of the disclosed direct stochastic processing.

In various embodiments, data interpretation for the disclosed direct stochastic processing includes interpreting a scalar as a single probability value. A stream of probabilities may be used to form probability density functions or vectors that may be stochastically processed. In embodiments, processing can be both powerful and simple. For example, probabilities can be compared to one another by taking a difference, which can be implemented by a low-cost subtraction operation. The disclosed stochastic learning can be expressed in both the discrete and continuous domains, despite that some embodiments described below are in the discrete domain for purposes of explanation.

For purposes of performing stochastic learning, supplied data (e.g., the data 140 referred to herein) is used according to various disclosed embodiments. Each portion of data (e.g., a particular string of data or data identified within a time period) is called a variable 134 and is interpreted as a stochastic variable without the need for translation or recoding. This contrasts conventional ML that employs feature engineering that transforms the data first before the data can be used learning. An example of feature engineering is “maximum relevance-minimum redundancy” (MRMR), which is an algorithm used by Uber's ML platform for finding the minimal-optimal subset of features. Such feature engineering at least partially destroys information within data that could otherwise be employed in AI processing efforts. Because there is no way of knowing what information is relevant and what is not, feature engineering can be counter-productive to achieving useful results from ML.

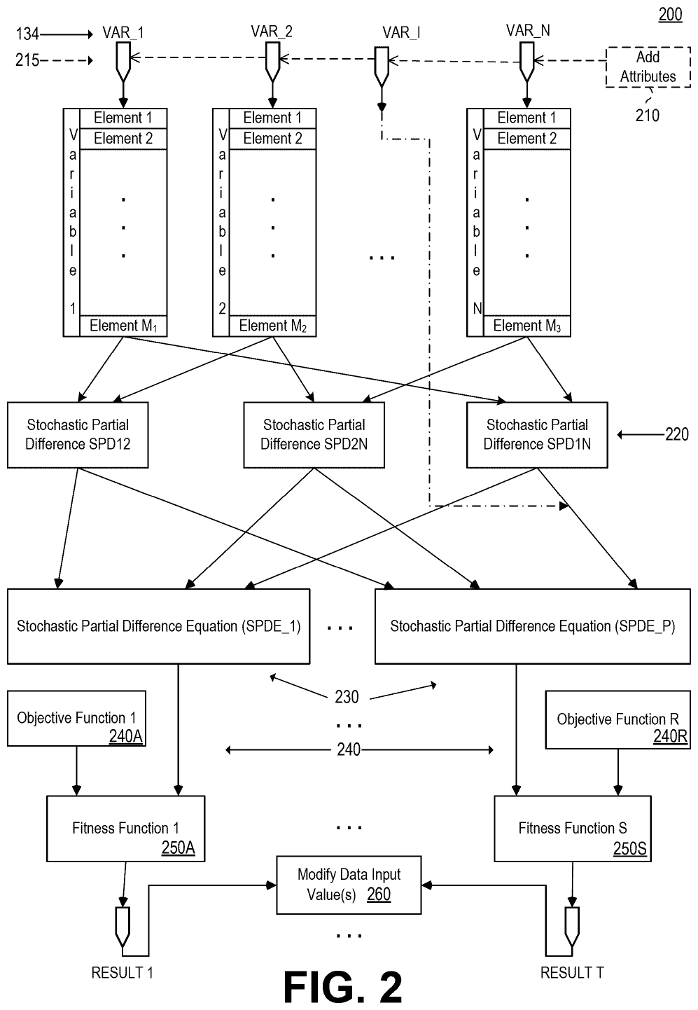

In various embodiments, each variable 134 includes dimensionality (e.g., be a scalar, a vector, a matrix, a tensor, or the like) and thus each variable 134 may be multidimensional. In embodiments, each value of a multidimensional variable is an element for purposes of this disclosure (see elements within variables illustrated in FIG. 2). Elements may have missing data, may be irregular, and may be sparse. Thus, the form of the elements is unimportant to the eventual stochastic processing. Variables 134 and elements may have optional attributes 136, which enables traceability with respect to relationships between the variables 134 and elements.

In varied embodiments, the attributes 136 are either explicit or implicit. The explicit attributes 136 may include data type (e.g., ordinal, metric, categorical) and a time period, e.g., may be associated with the same time period or adjacent time period(s). In embodiments, a time period has a starting time and an ending time. Time periods whose start and end times are the same are instants in time. In embodiments, elements inherit the attributes of an originating variable.

In some embodiments, the implicit attributes include elements that are related to each other by information distances in time (e.g., with respect to time) and space (e.g., with respect to another variable). Elements can also be implicit attributes of one another, with respect to their information distances. Thus, the implicit attributes can include, but not be limited to, an information distance in time, an information distance in space, or information of an element in another, related variable. The term “information distance” can indicate a difference between data values, e.g., which may differ over time. In various embodiments, the processing device 124 identifies variables 134 as well as constituent elements and attributes 136 of these variables 134 as key values 144 useable to index the data within a storage device 160. In these embodiments, the key values 144 are thus also useable for data retrieval from the storage device 160 or from other system or device to which the computing system 120 is communicatively coupled over the network 115.

FIG. 2 is an operational flow chart illustrating a method 200 of performing stochastic learning that enables dynamic modification of data inputs to an application according to at least some embodiments. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments related to stochastic learning, the method 200 is performed by the computing system 120 (FIG. 1).

In some embodiments, the processing logic detects a plurality of the variables 134 (VAR_1 to VAR_N), which may be part of the data 140 (see FIG. 1). In some embodiments, at operation 210, the processing logic optionally adds attributes 136 to these variables 134, e.g., as being related to the variables 134 or the underlying data 140 (see FIG. 1). In some embodiments, adding the attributes 136 includes relating the attributes in the memory 130 to corresponding one or more variables 134, which may group some attributes together according to a variable or across variables.

In at least some embodiments, at operation 215, the processing logic optionally groups a subset of the plurality of variables 134 based on the subset having related attributes 136. By default, the variables 134 may belong to a global group, e.g., at least by being related to one or more data inputs to the application 142. In some embodiments, the variables 134 associated with like data are separately grouped together in order to process that grouped data together. Optionally, the variables 134 may be grouped by one or more attributes 136. Some variables 134 that are grouped may have cross-relational attributes and thus could be grouped by more than one attribute 136. Similarly, some variables may simultaneously be members of multiple groups, e.g., due to cross-relational attributes 136 of those variables 134. Thus, each variable 134 (VAR_1 through VAR_N) may have been derived from a subset of variables 134 that have been grouped at operation 215 and thus can be treated as a single variable for purposes of the below stochastic processing.

At operation 220, the processing logic determines stochastic partial differences (SPD) between elements of respective variables 134 of the plurality of variables. Thus, with reference to FIG. 2, examples of stochastic partial differences include a SPD(1,2) formed between elements of VAR_1 and VAR_2, a SPD2N formed between elements of VAR_2 and VAR_N, and a SPD(1,N) formed between elements of VAR_1 and VAR_N. It should be readily apparent that many more additional intermediate SPDs could be generated given a number of intermediate variables between VAR_2 and VAR_N.

With additional reference to operation 220, determining the stochastic partial differences between the elements of respective variables 134 may include determining the partial differences in one of dependence form with respect to space (e.g., y/dx) and/or in finite difference form with respect to time (e.g., x/dx). In some embodiments, before operation 220 is performed, the processing logic determines a weighted binary value for a plurality of bits of the data 140. Then, the processing logic employs the weighted binary value to determine the stochastic partial difference between the elements of the respective multidimensional variables. In some embodiments, if one or more of the variables 134 come from grouped attributes or other grouping (discussed previously), e.g., a variable is based on a subset of related variables, at operation 220, the processing logic determines the stochastic partial differences is between elements of the respective variables of the subset.

At operation 230, the processing logic combines respective stochastic partial differences into groups including one or more stochastic partial difference equations (SPDEs). For example, as illustrated, the SPD12, SPD2N, and SPD1N may be combined into a SPDE_1 as well as into a separate SPDE_P. Other combinations of intermediate SPDs into SPDEs are also envisioned. As illustrated, an intermediate variable (VAR_I) of the plurality of variables 134 may be a scalar value. Thus, in some embodiments, this scalar value is directly applied as a weight to one or more of the stochastic partial differences (SPDs) generated at operation 220 before being combined at operation 230.

At operation 240, the processing logic evaluates, using a fitness measure criterion (or multiple fitness measure criteria), the one or more SPDEs in relation to an objective function (such as maximization of profit in financial trading, minimize error between writing samples in handwriting analysis, etc.). For example, a first objective function 240A may be employed to evaluate the SPDE_1 and an Rth objective function 240R may be employed to evaluate the SPDE_R. In some embodiments, the fitness measure criterion is based on a fitness function (e.g., of the objective and fitness functions 138 discussed previously) that are executable by the computing system 120 to determine whether the resultant SPDEs are predictive of input application value(s). In some embodiments, the fitness function (or criterion) measures progress towards reaching an outcome delineated by the objective function. For example, in some embodiments, a first fitness function 250A generates the fitness measure criterion (or criteria) of the first objective function 240A and an Sth fitness function generates the fitness measure criterion (or criteria) of the Rth objective function 240R. In some embodiments, the fitness measure criterion is one of a handwriting feature prediction in handwriting analysis, a price direction prediction in financial trading, or an information efficiency level modification in computing. Fitness may be evaluated for one or more objective functions simultaneously.

Many other examples of fitness measure criteria will be apparent to those skilled in the art and may be associated with other objectives (or outcome goals) employed in traditional ML/AI. In some embodiments, the fitness functions may be configured to indicate stable behavior such as by resulting in a linear response or a response that is within a threshold percentage of linear. Such stable behavior may be indicative that the SPDEs are predictive of the data input values. Thus, in various embodiments, when the first fitness function 250A results in stable behavior (e.g., generates a linear response), a first result output is generated that may act on the data input value(s). Similarly, when the Sth first function 250S results in stable behavior (e.g., generates a linear response), a T′th result is generated that may also act on the data input value(s).

Accordingly, at operation 240, the processing logic also determines, based on the evaluating, a prediction related to at least one data input to an application 142 executable by one of the computing system 120 or a second computing system communicatively coupled to the computing system, e.g., one or more computing systems/devices 110A, 110B, . . . 110N, the storage server 114, and/or at least one web server 116. This prediction may be, for example, that an equity will increase in share price, a commodity will decrease in share price, a currency will go up in value versus another currency, the demand for a certain integrated circuit (IC) chip will increase, and the like (with endless possibilities).

At operation 260, the processing logic modifies or adjusts a value of the at least one data input based on a result of evaluating the one or more SPDEs. In some embodiments, operations 240 and 260 further include the processing logic determining that the evaluating (operation 240) results in a linear response, within a threshold percentage, of the objective function before adjusting the value, at operation 260, of the at least one data input to the application 142. For example, the threshold percentage may be within an acceptance band or a tolerance specification. In this way, the processing logic ensures a proper fitness level of the results of applying an objective function before modifying or adjusting the data input value(s) to the application 142.

Thus, in various embodiments, learning occurs by pruning the high-dimensional space created by the SPDEs, e.g., by applying the objective function. This can be facilitated through direct measurement of the stochastic partials by the fitness function 250A or 250S. In some embodiments, the pruning effectively removes input data that does not contribute to information in support of the objective function, and thus can continuously work towards generating a predictive outcome as the input variables are updated or otherwise changed.

To provide an example for purposes of explaining application of the method 200, suppose that the first objective function 240A is to maximize profit from financial trades. In this example, variables 134 may include prices, volume, change in prices, econometric data, yields, and the like. In this example, the method 200 may focus on prices of a single equity, for example. Related attributes 136 to price includes open, high, low, and close for a given time period. At operation 220, the processing logic creates SPDs of values of these variables relative to each other. Those partials can be collected into SPDEs and evaluated for a level of linear, predictive response. If the response is sufficiently linear for any one or more of these SPDEs, the stochastic processing results may be used in predicting future price direction, e.g., a +1 is an upward price movement in the next time period and −1 is a downward price movement in the next time period. A similar approach may be taken for handwriting analysis, photo identification, and other similar applications 142.

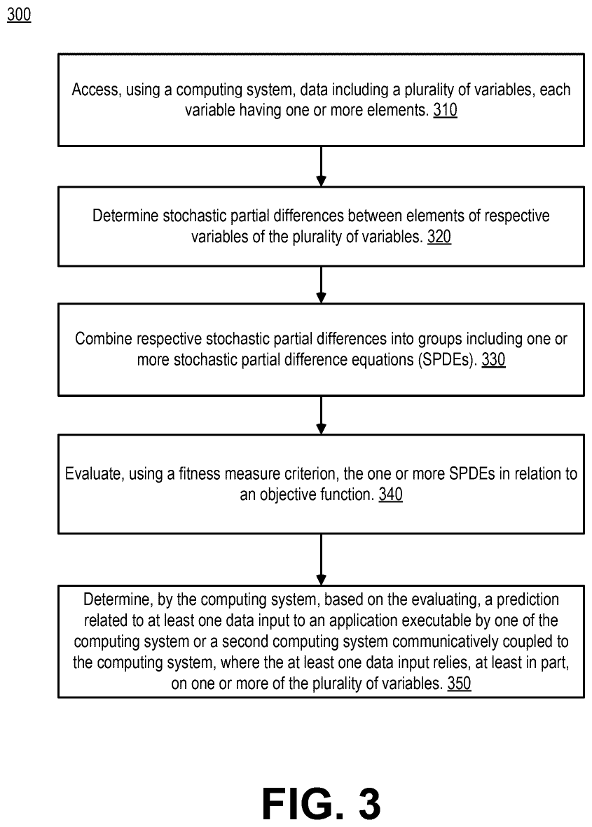

FIG. 3 is a flow chart of a method 300 for stochastic learning of a computing input according to at least one embodiment. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments related to stochastic learning, the method 300 is performed by the computing system 120 (FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic accesses data comprising a plurality of variables, each variable having one or more elements.

At operation 320, the processing logic determines stochastic partial differences between elements of respective variables of the plurality of variables.

At operation 330, the processing logic combines respective stochastic partial differences into groups comprising one or more stochastic partial difference equations (SPDEs).

At operation 340, the processing logic evaluates, using a fitness measure criterion, the one or more SPDEs in relation to an objective function.

At operation 350, the processing logic determines, based on the evaluating, a prediction related to (or of) at least one data input to an application executable by one of the computing system or a second computing system communicatively coupled to the computing system. In some embodiments, the at least one data input relies, at least in part, on one or more of the plurality of variables. In an extension to the method 300, the processing logic may also modify or adjust a value of the at least one data input based on a result of evaluating the one or more SPDEs.

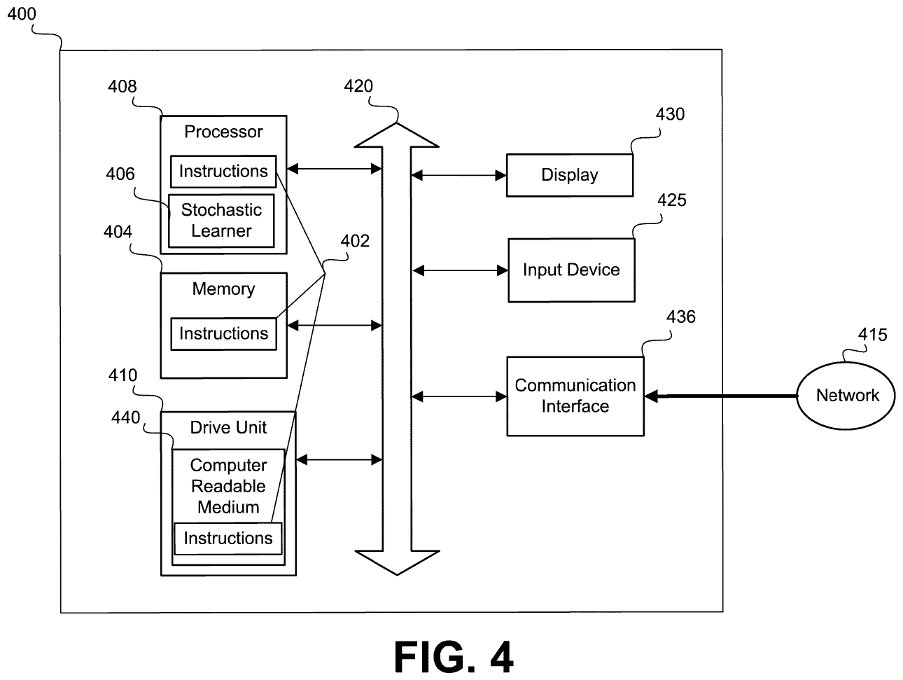

FIG. 4 is a general computer system 400, which may represent the computing system 120, the storage server 114, computing systems 110A-110N, and/or the Web server 116 or another device or system to which is referred or which is capable of executing the embodiment as disclosed herein. The computer system 400 may include an ordered listing of a set of instructions 402 that may be executed to cause the computer system 400 to perform one or more of the methods or computer-based functions disclosed herein. The computer system 400 may operate as a stand-alone device or may be connected to other computer systems or peripheral devices, e.g., by using a network 450.

In a networked deployment, the computer system 400 may operate in the capacity of a server or as a client-user computer in a server-client user network environment, or as a peer computer system in a peer-to-peer (or distributed) network environment. The computer system 400 may also be implemented as or incorporated into various devices, such as a personal computer or a mobile computing device capable of executing a set of instructions 402 that specify actions to be taken by that machine, including and not limited to, accessing the Internet or Web through any form of browser. Further, each of the systems described may include a collection of sub-systems that individually or jointly execute a set, or multiple sets, of instructions to perform one or more computer functions.

The computer system 400 may include a memory 404 on a bus 420 for communicating information. Code operable to cause the computer system to perform any of the acts or operations described herein may be stored in the memory 404. The memory 404 may be a random-access memory, read-only memory, programmable memory, hard disk drive or other type of volatile or non-volatile memory or storage device.

The computer system 400 may include a processor 408, such as a central processing unit (CPU) and/or a graphics processing unit (GPU). The processor 408 may include one or more general processors, digital signal processors, application specific integrated circuits, field programmable gate arrays, digital circuits, optical circuits, analog circuits, combinations thereof, or other now known or later-developed devices for analyzing and processing data. The processor 408 may implement the set of instructions 402 or other software program, such as manually-programmed or computer-generated code for implementing logical functions. The logical function or system element described may, among other functions, process and/or convert an analog data source such as an analog electrical, audio, or video signal, or a combination thereof, to a digital data source for audio-visual purposes or other digital processing purposes such as for compatibility for computer processing.

The processor 408 may include a transform modeler 406 or contain instructions for execution by a transform modeler 406 provided a part from the processor 408. The transform modeler 406 may include logic for executing the instructions to perform the transform modeling and image reconstruction as discussed in the present disclosure.

The computer system 400 may also include a disk (or optical) drive unit 410. The disk drive unit 410 may include a non-transitory computer-readable medium 440 in which one or more sets of instructions 402, e.g., software, can be embedded. For example, the disk drive unit 410 may be a non-transitory computer-readable storage medium storing instructions such as the instructions 402. Further, the instructions 402 may perform one or more of the operations as described herein. The instructions 402 may reside completely, or at least partially, within the memory 404 and/or within the processor 408 during execution by the computer system 400. Accordingly, the data displayed and described above with reference to FIG. 1 may be stored in the memory 404 and/or the disk unit 410.

The memory 404 and the processor 408 also may include non-transitory computer-readable media as discussed above. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 400 may include an input device 425, such as a keyboard or mouse, configured for a user to interact with any of the components of system 400. It may further include a display 430, such as a liquid crystal display (LCD), a cathode ray tube (CRT), or any other display suitable for conveying information. The display 430 may act as an interface for the user to see the functioning of the processor 408, or specifically as an interface with the software stored in the memory 404 or the drive unit 410.

The computer system 400 may include a communication interface 436 that enables communications via the communications network 415. The network 415 may include wired networks, wireless networks, or combinations thereof. The communication interface 436 network may enable communications via a number of communication standards, such as 802.11, 802.17, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. A computer system or other apparatus adapted for carrying out the methods described herein is suited to the present disclosure. A typical combination of hardware and software may be a general-purpose computer system with a computer program that, when being loaded and executed, controls the computer system such that it carries out the methods described herein. Such a programmed computer may be considered a special-purpose computer.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

The disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms, operations, and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the disclosure is not described with reference to any particular programming language. It will be appreciated that a variety of programming languages can be used to implement the teachings of the disclosure as described herein.

The disclosure can be provided as a computer program product, or software, that can include a machine-readable medium having stored thereon instructions, which can be used to program a computer system (or other electronic devices) to perform a process according to the disclosure. A machine-readable medium includes any mechanism for storing information in a form readable by a machine (e.g., a computer). In some embodiments, a machine-readable (e.g., non-transitory computer-readable) medium includes a machine (e.g., a computer) readable storage medium such as a read only memory (“ROM”), random access memory (“RAM”), magnetic disk storage media, optical storage media, flash memory components, etc.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” or the like throughout is not intended to mean the same implementation or implementation unless described as such. One or more implementations or embodiments described herein may be combined in a particular implementation or embodiment. The terms “first,” “second,” “third,” “fourth,” etc. as used herein are meant as labels to distinguish among different elements and may not necessarily have an ordinal meaning according to their numerical designation.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
accessing, using a computing system, data comprising a plurality of variables, each variable having one or more elements;
determining stochastic partial differences between elements of respective variables of the plurality of variables;
combining respective stochastic partial differences into groups comprising one or more stochastic partial difference equations (SPDEs);
evaluating, using a fitness measure criterion, the one or more SPDEs in relation to an objective function; and
determining, by the computing system, based on the evaluating, a prediction related to at least one data input to an application executable by one of the computing system or a second computing system communicatively coupled to the computing system, wherein the at least one data input relies, at least in part, on one or more of the plurality of variables.

2. The method of claim 1, further comprising:
determining a weighted binary value for a plurality of bits of the data, wherein determining the stochastic partial difference between the elements of the respective variables employs the weighted binary value; and
adjusting a value of the at least one data input based on a result of evaluating the one or more SPDEs.

3. The method of claim 2, further comprising determining that the result of evaluating the one or more SPDEs is in a linear response and within a threshold percentage of the objective function before adjusting the value of the at least one data input.

4. The method of claim 1, wherein determining the stochastic partial differences between the elements of respective variables comprises determining the partial differences in one of dependence form with respect to space or in finite difference form with respect to time.

5. The method of claim 1, further comprising grouping a subset of the plurality of variables based on the subset having related attributes, wherein determining the stochastic partial differences is between elements of the respective variables of the subset.

6. The method of claim 5, wherein the related attributes comprise at least one of a data type, a time period, an information distance in time, an information distance in space, or information of an element in another variable related within a stochastic partial difference.

7. The method of claim 5, further comprising employing at least one of the subset of the plurality of variables, the one or more elements, or the related attributes as key values useable to index the data within a storage device.

8. The method of claim 1, wherein at least one variable of the plurality of variables has multiple dimensions and each value of the multidimensional variable is an element of the one or more elements.

9. The method of claim 1, wherein the fitness measure criterion is one of a handwriting feature prediction in handwriting analysis, a price direction prediction in financial trading, or an information efficiency level modification in computing.

10. The method of claim 1, wherein the fitness measure criterion is based on a fitness function executable by the computing system.

11. A computing system comprising:
one or more processing devices; and
memory communicatively coupled with and readable by the one or more processing devices and having stored therein processor-readable instructions which, when executed by the one or more processing devices, cause the one or more processing devices to perform operations comprising:
accessing data comprising a plurality of variables, each variable having one or more elements;
determining stochastic partial differences between elements of respective variables of the plurality of variables;
combining respective stochastic partial differences into groups comprising one or more stochastic partial difference equations (SPDEs);
evaluating, using a fitness measure criterion, the one or more SPDEs in relation to an objective function; and
determining, based on the evaluating, a prediction related to at least one data input to an application executable by the one or more processing devices, wherein the at least one data input relies, at least in part, on one or more of the plurality of variables.

12. The computing system of claim 11, wherein the operations further comprise:
determining a weighted binary value for a plurality of bits of the data, wherein determining the stochastic partial difference between the elements of the respective variables employs the weighted binary value; and
adjusting a value of the at least one data input based on a result of evaluating the one or more SPDEs.

13. The computing system of claim 12, wherein the operations further comprise determining that the result of evaluating the one or more SPDEs is in a linear response and within a threshold percentage of the objective function before adjusting the value of the at least one data input.

14. The computing system of claim 11, wherein determining the stochastic partial differences between the elements of respective variables comprises determining the partial differences in one of dependence form with respect to space or in finite difference form with respect to time.

15. The computing system of claim 11, wherein the operations further comprise grouping a subset of the plurality of variables based on the subset having related attributes, wherein determining the stochastic partial differences is between elements of the respective variables of the subset.

16. The computing system of claim 15, wherein the related attributes comprise at least one of a data type, a time period, an information distance in time, an information distance in space, or information of an element in another variable related within a stochastic partial difference.

17. The computing system of claim 15, wherein the operations further comprise employing at least one of the subset of the plurality of variables, the one or more elements, or the related attributes as key values useable to index the data within a storage device.

18. The computing system of claim 11, wherein at least one variable of the plurality of variables has multiple dimensions and each value of the multidimensional variable is an element of the one or more elements.

19. The computing system of claim 11, wherein the fitness measure criterion is one of a handwriting feature prediction in handwriting analysis, a price direction prediction in financial trading, or an information efficiency level modification in computing.

20. The computing system of claim 11, wherein the fitness measure criterion is based on a fitness function executable by the one or more processing devices.

21. A non-transitory computer-readable storage medium storing instructions, which when executed by one or more processing devices of a computing system, causing the processing devices to activate operations comprising:
accessing data comprising a plurality of variables, each variable having one or more elements;
determining stochastic partial differences between elements of respective variables of the plurality of variables;
combining respective stochastic partial differences into groups comprising one or more stochastic partial difference equations (SPDEs);
evaluating, using a fitness measure criterion, the one or more SPDEs in relation to an objective function; and
determining, based on the evaluating, a prediction related to at least one data input to an application executable by one of the computing system or a second computing system communicatively coupled to the computing system, wherein the at least one data input relies, at least in part, on one or more of the plurality of variables.
